(19) United States
(12) Patent Application Publication
(10) Pub. No.: US 2010/0277058 A1
(43) Pub. Date: Nov. 4, 2010

(54) COLD CATHODE FLUORESCENT LAMP

(75) Inventors: Toshikazu Sugimura, Shinagawa-ku (JP); Hitoshi Hata, Shinagawa-ku (JP); Shinobu Sawayama, Shinagawa-ku (JP); Isao Kawanishi, Minato-ku (JP); Tatsuya Takahashi, Minato-ku (JP)

Correspondence Address: SUGHRUE MION, PLLC, 2100 PENNSYLVANIA AVENUE, N.W., SUITE 800, WASHINGTON, DC, 20037, US

(73) Assignees: NEC LIGHTING, LTD., Shinagawa-ku, Tokyo (JP); SUMITOMO METAL MINING CO., LTD., Minato-ku, Tokyo (JP)

(21) Appl. No.: 12/677,783

(22) PCT Filed: Aug. 22, 2008
(86) PCT No.: PCT/JP2008/064974

§ 371 Date: Jul. 6, 2010

(30) Foreign Application Priority Data
Sep. 13, 2007 (JP) 2007-238068
Aug. 6, 2008 (JP) 2008-203306

(51) Int. Cl. H01J 61/06

(52) U.S. Cl. 313/491

(57) ABSTRACT

There is provided a cold cathode fluorescent lamp that has excellent sputtering resistance and long life, even if high tube current is applied, and can be easily manufactured at low cost. In a cold cathode fluorescent lamp comprising a transparent tube having a fluorescent layer provided on an inner wall surface, containing a rare gas and mercury inside, and having both ends enclosed by sealing members, electrodes provided near both ends inside the transparent tube, and lead wires connected to the electrodes and provided through the sealing members, the electrode contains nickel as a main component and contains cerium metal or cerium oxide.

### TECHNICAL FIELD

The present invention relates to a cold cathode fluorescent lamp, and more particularly to a cold cathode fluorescent lamp in which a longer life is intended by improving the sputtering resistance of the electrodes even if high tube current is applied.

### BACKGROUND ART

Cold cathode fluorescent lamps are frequently used for backlights applied to liquid crystal displays such as for televisions or computers, light sources for reading for facsimiles or the like, light sources for the erasers of copying machines, various displays, or the like because the cold cathode fluorescent lamps are excellent in high brightness, high color rendering, long life, low power consumption, or the like. In this type of cold cathode fluorescent lamp, voltage is applied to electrodes provided near both ends of a transparent tube of glass or the like containing a rare gas and mercury airtight inside, to ionize the rare gas by a slight amount of electrons present in the transparent tube, and the ionized rare gas is allowed to collide with the electrodes to release secondary electrons to cause glow discharge, thereby exciting the mercury to radiate ultraviolet rays. Fluorescent material in a fluorescent layer provided on the inner wall of the transparent tube receiving the ultraviolet rays emits visible light.

A cup-shaped electrode in which a reduction in tube voltage and power consumption can be intended is used as the electrode of this type of cold cathode fluorescent lamp, and the cup-shaped electrodes are located at both ends inside the transparent tube so that the cup-shaped openings are opposed to each other. Nickel has been used as the material of the electrode because nickel has low melting temperature, is easily processed, is excellent in sputtering resistance for mercury and rare gas ions and the like, provides good welding to Kovar and the like generally used for the sealing member, and has durability that can sufficiently endure use at a tube current of 4 to 5 mA. However, cold cathode fluorescent lamps used in the large screens of televisions and the backlight units of high brightness liquid crystal displays in recent years need to have durability against a tube current of 5 mA or more.

High melting point sintered metals, such as molybdenum and niobium, which are excellent in sputtering resistance even for a large load, have a low work function, and can reduce the discharge start voltage, have been used as the electrodes of the cold cathode fluorescent lamps, instead of nickel.

However, on the other hand, the degradation of the lead wire, which occurs when the lead wire is welded to the electrode of such a high melting point sintered metal, and the degradation of the sealing members, which occurs when both ends of the transparent tube are sealed, have been problems. Also, these electrode materials are more expensive than nickel, the forming of electrodes using these is difficult, and consumables, such as a jig used during forming, are necessary. As a result, the electrodes are significantly expensive. Therefore, nickel has been reconsidered as the electrode material, and further nickel electrodes excellent in sputtering resistance have been developed. For example, a discharge lamp comprising electrodes as a two-layer structure, with a first layer of at least one of nickel, stainless, iron, aluminum, and copper, and a second layer in which a boron compound, tungsten, barium, rare earth, and/or other metal oxides are contained in at least one metal of nickel, stainless, iron, aluminum, and copper (Patent Document 1) has been reported. Also, a cold cathode discharge lamp comprising discharge electrodes of a composite metal of a lanthanide series metal and nickel, or the like to reduce the discharge start voltage (Patent Document 2) has been conventionally known.

However, problems of the discharge lamp described in Patent Document 1 are that the configuration of the electrode is complicated, thereby, the number of manufacturing steps increases, and the adjustment of the manufacturing steps is complicated, decreasing manufacturing efficiency. Also, in the cold cathode discharge lamp described in Patent Document 2, consideration is not given to the suppression of a decrease in sputtering resistance due to the generation of heat for high current such that the tube current is more than 10 mA, and when a lead wire, such as a Kovar wire, for supplying a power supply is connected to the electrode, when the electrodes are placed and the transparent tube is enclosed by stems, or the like, the effect of suppressing the degradation of the Kovar wire and the oxidation of the electrodes is not obtained.

Patent Document 1: Japanese Patent Laid-Open No. 2005-183172

Patent Document 2: Japanese Patent Laid-Open No. 59-121750

### DISCLOSURE OF THE INVENTION

### Problems to be Solved by the Invention

It is an object of the present invention problem to provide a cold cathode fluorescent lamp comprising electrodes that have resistance to surface oxidation during manufacture, have excellent sputtering resistance and long life, even if high tube current is applied during the use of the lamp, and can be easily manufactured at low cost.

### Means for Solving the Problems

As a result of diligent study, the present inventors have obtained the finding that when the electrodes of a cold cathode fluorescent lamp comprises nickel as the main component and contains cerium metal or cerium oxide, the electrodes have resistance to surface oxidation during manufacture, and are excellent in sputtering resistance even if a high current of 10 mA or more is applied during the use of the lamp, and a longer life of the cold cathode fluorescent lamp can be intended. This finding has led the inventors to complete the present invention.

Specifically, the present invention relates to a cold cathode fluorescent lamp comprising a transparent tube having a fluorescent layer provided on an inner wall surface, containing a rare gas and mercury inside, and having both ends enclosed by sealing members, electrodes provided near both ends inside the transparent tube, and lead wires connected to the electrodes and provided through the sealing members, characterized in that the electrode contains nickel as a main component and contains cerium metal or cerium oxide.

### ADVANTAGES OF THE INVENTION

The cold cathode fluorescent lamp of the present invention has resistance also to surface oxidation during manufacture, has excellent sputtering resistance and long life, even if high tube current is applied during the use of the lamp, and can be easily manufactured at low cost.

### BRIEF DESCRIPTION OF THE DRAWINGS

FIG. 1 is a view showing the crystal structure of the electrode of the cold cathode fluorescent lamp of the present invention;

FIG. 2 is a view showing a schematic cross-sectional view of one example of the cold cathode fluorescent lamp of the present invention; and

FIG. 3 is a view showing the electrode of the cold cathode fluorescent lamp shown in FIG. 2.

### DESCRIPTION OF SYMBOLS

1 cold cathode fluorescent lamp
2 glass tube (transparent tube)
3 glass bead
4 fluorescent layer
5 internal space
7 electrode
8 bottom surface portion
9 lead wire
10 opening

### BEST MODE FOR CARRYING OUT THE INVENTION

The cold cathode fluorescent lamp of the present invention is a cold cathode fluorescent lamp comprising a transparent tube having a fluorescent layer provided on an inner wall surface, containing a rare gas and mercury inside, and having both ends enclosed by sealing members, electrodes provided near both ends inside the transparent tube, and lead wires connected to the electrodes and provided through the sealing members, characterized in that the electrode contains nickel as a main component and contains cerium metal or cerium oxide.

The transparent tube used in the cold cathode fluorescent lamp of the present invention may be of any material that transmits visible light, such as glass, for example, silicate glass, borosilicate glass, zinc borosilicate glass, lead glass, and soda glass. The shape of the transparent tube may be any shape, such as a straight tube type and a curved type. The tube bore may be any size, for example, 1.5 to 6.0 mm. The thickness of the transparent tube can be appropriately selected according to the purpose of use, but is preferably a thickness of 0.15 to 0.60 mm, with the above bore.

The fluorescent layer is provided over substantially the entire inner wall surface of the transparent tube. The fluorescent layer contains fluorescent material that is excited by ultraviolet rays radiated from mercury described later and emits visible light. For such fluorescent material, one that emits light with the target wavelength can be selected according to the purpose of use. Examples of the fluorescent material can include halophosphate fluorescent substance, rare earth fluorescent substance, or the like. These can also be appropriately combined and used to emit white light. The thickness of the fluorescent layer is preferably 11 μm or more and 28 μm or less.

Mercury, which is excited by discharge to produce ultraviolet rays, and a rare gas appropriately selected from argon, xenon, neon, or the like are introduced into the transparent tube. Discharge electrons produced in the transparent tube collide with mercury atoms, and the mercury atoms produce ultraviolet rays including 253.7 nm, which excites the fluorescent material. The amount of mercury introduced can include an amount such that the vapor pressure during the lighting of the fluorescent lamp is, for example, 1 to 10 Pa. The amount of rare gas introduced can include an amount such that the pressure during the lighting of the fluorescent lamp is, for example, 5000 Pa to 11000 Pa.

The electrodes provided at both ends inside the transparent tube comprise nickel as the main component and contain cerium metal or cerium oxide. The nickel as the main component is preferably nickel metal. The nickel may be contained in the electrode as the only substance, except cerium metal or cerium oxide, and as the main component. The electrodes containing nickel as the main component can suppress the degradation of the lead wires when the lead wires are connected to the electrodes, and the degradation of the sealing members when the ends of the transparent tube are enclosed by the sealing members. Also, the electrodes can suppress the oxidation of themselves and are excellent in processing and forming properties.

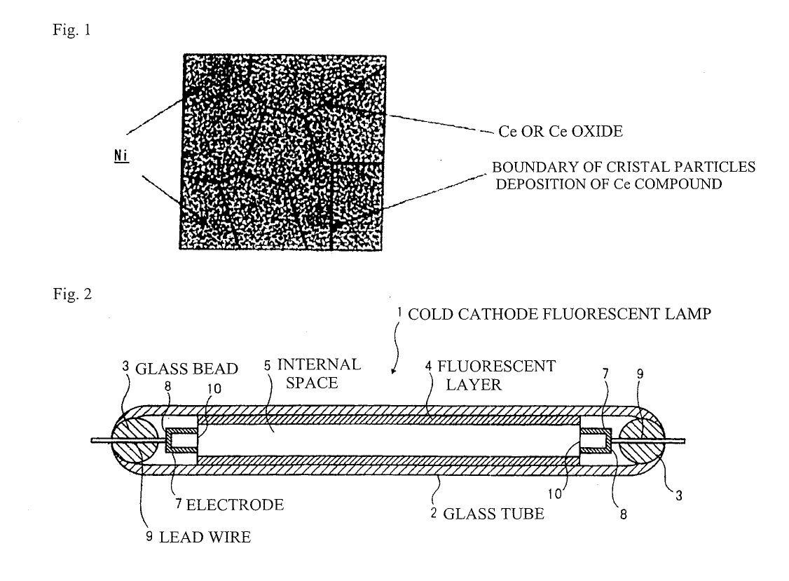

The cerium metal or cerium oxide contained in the electrode is present at the interfaces of nickel crystal particles, as shown in FIG. 1. When an ionized rare gas collides with the electrode, the interfaces between the nickel crystal particles tend to be sputtered first. However, the presence of the cerium metal or cerium oxide suppresses the interface sputtering and provides excellent sputtering resistance to the electrode. Also, even if the oxidation of the boundary portions of crystal particles due to residual oxygen during the manufacture of the lamp occurs, the cerium metal or cerium oxide has the function of reinforcing the bonding force of the boundaries of crystal particles and can further improve the sputtering resistance. The content of the cerium metal in the electrode is preferably 0.11% by mass or more and 1.35% by mass or less. When the content of the cerium metal is in this range, the electrodes have excellent sputtering resistance for rare gas ions even if a current of more than 10 mA is applied during the use of the lamp, and a longer life of the cold cathode fluorescent lamp can be intended.

The cerium oxide may be any cerium oxide, such as dicerium(III) trioxide (Ce₂O₃), cerium(IV) dioxide (CeO₂). Unstable cerium(III) oxide can also be used as a stable complex. The content of the cerium oxide in the electrode is preferably 0.15% by mass or more and 1.61% by mass or less. When the content of the cerium oxide is in this range, the cerium oxide is present between the interfaces of the nickel crystal particles and suppresses interface sputtering during the use of the lamp, and the electrodes have excellent sputtering resistance for rare gas ions even if a current of more than 10 mA is applied, thereby, a longer life of the cold cathode fluorescent lamp can be intended. These cerium oxides can also be used with cerium metal in the electrode. The content of the cerium oxide at this time is converted into the content of the cerium metal, and the total amount of the cerium oxide and the cerium metal is preferably in the range of the above cerium metal content.

The above electrode preferably further comprises any one or two or more of lanthanum, neodymium, or praseodymium. These may be contained as metal, and may be contained as oxide or the like. Lanthanum, neodymium, or praseodymium has the function of uniformly dispersing cerium metal in the boundaries of nickel polycrystalline particles, and a finer structure with the addition of cerium metal is stabilized. Therefore, the function of cerium metal and its oxide is reinforced, and more excellent sputtering resistance is provided to the electrodes even if a current of more than 10 mA is applied during the use of the lamp, thereby, a longer life of the cold cathode fluorescent lamp can be intended. These may be preferably contained in the range of 0.01% by mass or more and 0.45% by mass or less, in total.

Also, the above electrode preferably further comprises yttrium. Yttrium may be contained as metal, and may be contained as oxide or the like. Yttrium is selectively deposited in the boundaries of crystal particles, and therefore, a finer electrode structure is intended, and the sputtering resistance is improved. Also, yttrium is an electron-emitting substance with a low work function, and therefore, the starting properties in a dark space can also be simultaneously improved. The content of yttrium metal in the electrode is preferably 0.05% by mass or more and 0.5% by mass or less. When the content of yttrium metal in the electrode is 0.05% by mass or more, the sputtering resistance is excellent. When the content is 0.5% by mass or less, the processability is excellent.

Also, the above electrode preferably comprises titanium. Titanium is a metal that contributes to structure control, and titanium becomes a deposit to suppress the electrode structure becoming coarser. Therefore, the electrode structure becomes fine, and the sputtering resistance of the electrode is improved. The content of titanium in the electrode is preferably 0.01% by mass or more and 0.05% by mass or less. When the content of titanium in the electrode is 0.01% by mass or more, the sputtering resistance is excellent. When the content is 0.05% by mass or less, the processability is excellent.

The above electrode further preferably contains yttrium and titanium. The synergistic action of yttrium and titanium promotes a finer structure, provides remarkable sputtering resistance to the electrode, and can also simultaneously provide starting properties in the darkness.

In the above electrode, cerium metal or cerium oxide, and further, any one or two or more of lanthanum, neodymium, or praseodymium, yttrium, and titanium are included in nickel, the main component, thereby, the nickel crystal particles in the electrode can be formed as fine particles with an average particle diameter of, for example, 25 μM or less. The fine particles make bonding between particles strong, and the sputtering resistance of the electrode can be significantly improved.

Here, the average particle diameter of the crystal particles can be obtained from particle diameters obtained by a comparison method using optical microscope observation for the electrode surface etched with acid. Specifically, conforming to a method described in “Introductory Metal Materials and Structures” (P 189 to 193) written and edited by the Japan Society for Heat Treatment, published by the Publishing Taiga Shuppan Co., Ltd., in a circle with a diameter of 80 mm on a photoprint, 100 times as large as a circle with an actual field diameter of 0.8 mm, magnified by an optical microscope, a corresponding particle size number is determined, compared to a standard diagram, to obtain an average particle diameter. For example, if a particle magnified 100 times diameters is positioned at between particle size numbers 7 and 8 comparing to the standard diagram, the particle diameter can be determined 25 μm.

The above electrode is preferably cup-shaped because a reduction in tube voltage and power consumption can be improved. The above electrodes are preferably located near both ends inside the transparent tube, with the cup-shaped openings opposed to each other. For making the cup-shaped electrode, it is possible to bond members cut from a plate-shaped ingot to fabricate a cup-shaped electrode. It is easy that a member is cut in a circular shape, pressed, and formed in a cup shape electrode with a fine structure. Also, the cup-shaped electrode can be easily formed by the so-called header working in which a wire with the desired length is cut, and a section is axially hammered to form a recess to form in a cup shape. The shape of the cup can be appropriately selected according to the inner diameter of the transparent tube, and the output of the lamp. For example, the cup can have an outer diameter of 1.05 to 2.75 mm, a length of 3 to 8 mm, or the like.

To the above electrode, a lead wire for connecting the electrode to an external power supply is connected. The lead wire can be provided, with one end fused to the bottom surface of the electrode, and the other end protruding outside through the sealing member for enclosing an end of the transparent tube. The lead wire is preferably one with heat resistance to suppress degradation due to heating when the lead wire is fused to the electrode, and heating when the enclosing member is adhered to the transparent tube. Also, a Kovar wire with a dual structure in which a copper core wire is covered with Kovar, or the like can be connected and used as the lead wire in the lamp, and a Dumet wire or the like can be connected and used as the external lead wire so that the heat of the electrode during the use of the lamp can be efficiently released outside the transparent tube.

The sealing member, such as a stem, for enclosing both ends of the transparent tube containing the above rare gas and mercury is provided with the above lead wire passed through the sealing member, and has the function of fixing the electrode via the lead wire. For example, a glass bead, Kovar, and the like are used for the sealing member.

In the cold cathode fluorescent lamp of the present invention, a protective layer may be provided between the fluorescent layer and the transparent tube to suppress the leakage of ultraviolet rays radiated from mercury, or the like outside the transparent tube, or to suppress the degradation of the transparent tube due to mercury or the like. The protective layer can be formed using, for example, metal oxide, such as yttrium oxide and aluminum oxide, or the like.

For the method for manufacturing the above cold cathode fluorescent lamp, an ingot material in which nickel and cerium metal or cerium oxide, and lanthanum, neodymium, praseodymium, yttrium, or titanium as required are melted is used to make an ingot or a wire, and this is used to form the above cup shape or the like to form an electrode.

For the method for fabricating the electrode, specifically, the ingot material can be prepared by melting nickel, cerium metal or cerium oxide, and the like near the melting point of nickel. Then, this ingot material is cast in a mold to provide an ingot of a nickel alloy comprising these metals. Alternatively, the ingot material is used to form a wire. Further, the obtained ingot or wire can be subjected to plastic working by hot rolling or cold rolling to provide a thin plate shape with a thickness of 0.1 to 0.2 mm, or a wire with a diameter of 1 to 2.6 mm, or the like. After the hot rolling or cold rolling, the ingot or the wire is annealed to remove internal strain to improve ductility, and is surface-polished. Also, pressing can be performed or the wire can be subjected to header working to obtain an electrode with a fine crystal structure. A lead wire is bonded to the obtained electrode. In the case of a Kovar wire, the electrode and the Kovar can be directly integrated by resistance welding or laser welding.

For the formation of the fluorescent layer on the inner wall of the transparent tube, a dispersion in which the above fluorescent material is dispersed in a solvent is prepared, applied to the inner wall surface of a transparent tube of glass or the like with a predetermined shape by a method, such as immersion or spraying, and dried to form a fluorescent layer with the above thickness. Then, electrodes are located at the ends of the transparent tube, and the ends of the transparent tube are enclosed by sealing members, with lead wires passed through the sealing members. Mercury and a rare gas are introduced into the transparent tube, thereby, a cold cathode fluorescent lamp can be manufactured.

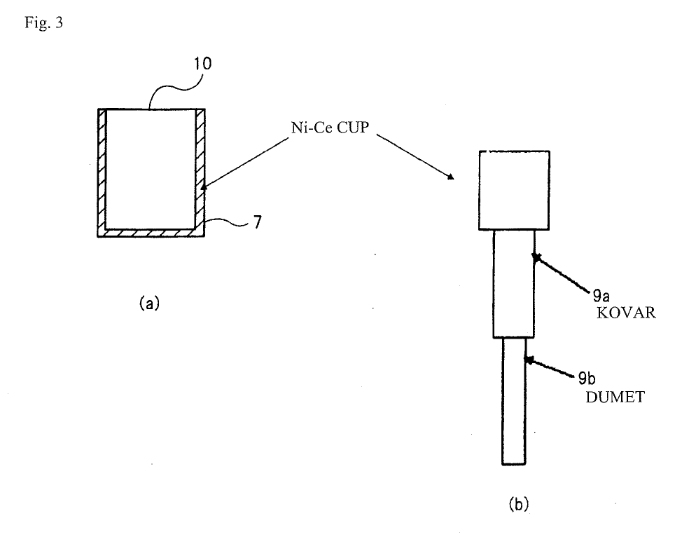

A cold cathode fluorescent lamp for the backlight of a liquid crystal panel shown in FIG. 2 can be illustrated as one example of the cold cathode fluorescent lamp of the present invention. A cold cathode fluorescent lamp 1 shown in a schematic cross-sectional view in FIG. 2 is configured so that both ends of a glass tube 2 formed of borosilicate glass are sealed airtight by bead glass 3. The outer diameter of the glass tube 2 is in the range of 1.5 to 6.0 mm, preferably in the range of 1.5 to 5.0 mm. A fluorescent layer 4 is provided on the inner wall surface of the glass tube 2 over substantially the entire length of the inner wall surface. A predetermined amount of a rare gas and mercury are introduced in the internal space 5 of the glass tube 2 surrounded by the inner wall surface, and the internal pressure is reduced to about one several tenth of atmospheric pressure. Cup-shaped electrodes 7 containing the above components are located at both ends of the glass tube 2 in the longitudinal direction so that openings 10 are opposed to each other, as shown in a partial cross-sectional view in FIG. 3(a) and a partial side view in FIG. 3(b). One end of a Kovar wire 9a is welded to the bottom surface portion 8 of the cup-shaped electrode 7, and the other end is connected to a Dumet wire 9b provided outside the bead glass 3.

The above cold cathode fluorescent lamp comprises nickel as the main component, comprises a predetermined amount of cerium metal or cerium oxide, and contains a predetermined amount of lanthanum, neodymium, praseodymium, yttrium, or titanium as required. Therefore, discharge can be started at low voltage, the sputtering resistance for a rare gas is significantly improved, and a longer life of the cold cathode fluorescent lamp is intended.

### EXAMPLES

The present invention will be described below in more detail by Examples.

### Example 1

Starting raw materials, with 0.5% by mass of cerium metal added to nickel, were melted at a temperature equal to or higher than the melting point of nickel. This ingot material was cast in a mold and cooled to room temperature. Then, hot rolling, cold rolling, wire drawing, or the like was repeated to fabricate a wire material with a diameter of about 0.2 mm. The wire material was subjected to header working to fabricate a cup-shaped electrode with an outer diameter of 1.7 mm and a length of 5 mm. A Kovar wire with a diameter of 0.8 mm was welded to the bottom surface portion of the obtained electrode for integration.

The average diameter of crystal particles of the nickel of the electrode was measured by the comparison method. The average diameter of crystal particles of the nickel was 22 μm.

About 18 μm thick of a fluorescent material was applied to the inner wall surface of a glass tube with a bore of 2.0 mm. The electrodes to which the Kovar wire was fused were located at both ends of the glass tube so that the openings of the electrodes were opposed to each other, and the both ends of the glass tube were sealed by glass beads through which the Kovar wires were passed. Then, mercury and a rare gas were introduced to fabricate a cold cathode fluorescent lamp.

After the obtained cold cathode fluorescent lamp was lighted at a tube current of 10 mA, whether the sputtering resistance was good or not was evaluated according to observation of the amount of wear of the cup portion. The sputtering resistance was evaluated from the amount of wear of the cup portion of the electrode according to the following criteria. The result is shown in Table 1.

⊙: Very slight wear of the cup portion is seen.
◯: The wear of the cup portion is noted, but the electrode can be sufficiently used.
Δ: The wear of the cup portion is noted, but the electrode is in a limit range for use.
x: The wear of the cup portion is severe, and the electrode can not be used.

### Examples 2 to 40

A cold cathode fluorescent lamp was fabricated and the sputtering resistance was evaluated for the obtained cold cathode fluorescent lamp as in Example 1 except that the starting raw materials were changed to a composition shown in Table 1. The result is shown in Table 1.

### Comparative Examples 1 and 2

A cold cathode fluorescent lamp was fabricated and the sputtering resistance was evaluated for the obtained cold cathode fluorescent lamp as in Example 1 except that the starting raw materials were changed to a composition shown in Table 1. The result is shown in Table 1.

TABLE 1

| | Chemical composition | | | | | | | |
|---|---|---|---|---|---|---|---|---|
| | Ni | Ce | La | Pr | Nd | Y | Ti | Sputtering resistance |
| Ex. 1 | Bal. | 0.49 | — | — | — | — | — | ⊚ |
| Ex. 2 | Bal. | 1.03 | — | — | — | — | — | ⊚ |
| Ex. 3 | Bal. | 0.19 | — | — | — | — | — | ◯ |
| Ex. 4 | Bal. | 1.31 | — | — | — | — | — | ◯ |
| Ex. 5 | Bal. | 0.006 | — | — | — | — | — | Δ |
| Ex. 6 | Bal. | 0.009 | — | — | — | — | — | Δ |
| Ex. 7 | Bal. | 1.42 | — | — | — | — | — | Δ |
| Ex. 8 | Bal. | 1.59 | — | — | — | — | — | Δ |
| Ex. 9 | Bal. | 0.28 | 0.11 | 0.02 | 0.08 | — | — | ⊚ |
| Ex. 10 | Bal. | 0.11 | 0.03 | 0.02 | 0.03 | — | — | ◯ |
| Ex. 11 | Bal. | 0.75 | 0.29 | 0.08 | 0.17 | — | — | ◯ |
| Ex. 12 | Bal. | 0.005 | 0.001 | <0.001 | 0.001 | — | — | Δ |
| Ex. 13 | Bal. | 0.82 | 0.32 | 0.07 | 0.19 | — | — | Δ |
| Ex. 14 | Bal. | 0.29 | 0.13 | 0.02 | 0.08 | 0.29 | — | ⊚ |
| Ex. 15 | Bal. | 0.13 | 0.06 | 0.02 | 0.04 | 0.30 | — | ⊚ |
| Ex. 16 | Bal. | 0.76 | 0.29 | 0.09 | 0.17 | 0.29 | — | ⊚ |
| Ex. 17 | Bal. | 0.004 | 0.003 | 0.001 | 0.002 | 0.29 | — | ◯ |
| Ex. 18 | Bal. | 0.79 | 0.32 | 0.08 | 0.18 | 0.31 | — | Δ |
| Ex. 19 | Bal. | 0.28 | 0.11 | 0.04 | 0.08 | 0.07 | — | ⊚ |
| Ex. 20 | Bal. | 0.29 | 0.12 | 0.03 | 0.08 | 0.44 | — | ⊚ |
| Ex. 21 | Bal. | 0.29 | 0.10 | 0.03 | 0.08 | 0.03 | — | ◯ |
| Ex. 22 | Bal. | 0.28 | 0.11 | 0.04 | 0.06 | 0.61 | — | Δ |
| Ex. 23 | Bal. | 0.30 | 0.09 | 0.02 | 0.07 | — | 0.04 | ⊚ |
| Ex. 24 | Bal. | 0.13 | 0.04 | 0.01 | 0.02 | — | 0.03 | ⊚ |
| Ex. 25 | Bal. | 0.73 | 0.30 | 0.08 | 0.16 | — | 0.03 | ⊚ |
| Ex. 26 | Bal. | 0.005 | 0.002 | <0.001 | <0.001 | — | 0.03 | ◯ |
| Ex. 27 | Bal. | 0.83 | 0.31 | 0.09 | 0.18 | — | 0.04 | Δ |
| Ex. 28 | Bal. | 0.27 | 0.13 | 0.02 | 0.06 | — | 0.01 | ⊚ |
| Ex. 29 | Bal. | 0.28 | 0.12 | 0.03 | 0.07 | — | 0.05 | ⊚ |
| Ex. 30 | Bal. | 0.28 | 0.14 | 0.04 | 0.08 | — | 0.009 | ◯ |
| Ex. 31 | Bal. | 0.30 | 0.13 | 0.04 | 0.07 | — | 0.07 | Δ |
| Ex. 32 | Bal. | 0.29 | 0.12 | 0.03 | 0.07 | 0.28 | 0.03 | ⊚ |
| Ex. 33 | Bal. | 0.13 | 0.04 | 0.01 | 0.02 | 0.28 | 0.02 | ⊚ |
| Ex. 34 | Bal. | 0.77 | 0.27 | 0.06 | 0.18 | 0.30 | 0.02 | ⊚ |
| Ex. 35 | Bal. | 0.006 | 0.003 | <0.001 | 0.001 | 0.29 | 0.03 | ◯ |
| Ex. 36 | Bal. | 0.83 | 0.32 | 0.07 | 0.21 | 0.30 | 0.03 | Δ |
| Ex. 37 | Bal. | 0.28 | 0.14 | 0.05 | 0.06 | 0.03 | 0.04 | ◯ |
| Ex. 38 | Bal. | 0.30 | 0.13 | 0.04 | 0.08 | 0.57 | 0.03 | Δ |
| Ex. 39 | Bal. | 0.29 | 0.12 | 0.02 | 0.06 | 0.30 | 0.009 | ◯ |
| Ex. 40 | Bal. | 0.29 | 0.12 | 0.04 | 0.07 | 0.31 | 0.08 | Δ |
| Com. Ex. 1 | Bal. | — | — | — | — | — | — | X |
| Com. Ex. 2 | Bal. | — | 0.04 | 0.01 | 0.02 | — | — | X |

It is clear that the cold cathode fluorescent lamp of the present invention comprises electrodes that are excellent in sputtering resistance even if the tube current is at high voltage, and that the cold cathode fluorescent lamp is excellent in durability.

The present invention includes all matters described in the application documents of Japanese Patent Application No. 2007-238068 and Japanese Patent Application No. 2008-203306.

### INDUSTRIAL APPLICABILITY

The cold cathode fluorescent lamp of the present invention can improve the sputtering resistance of the electrodes, even if high tube current is applied, can be suitably used for backlights applied to liquid crystal displays such as for televisions and computers, light sources for reading for facsimiles or the like, light sources for the erasers of copying machines, various displays, or the like, and is industrially very useful.

1. A cold cathode fluorescent lamp comprising a transparent tube having a fluorescent layer provided on an inner wall surface, containing a rare gas and mercury inside, and having both ends enclosed by sealing members, electrodes provided near both ends inside the transparent tube, and lead wires connected to the electrodes and provided through the sealing members, characterized in that the electrode contains nickel as a main component and contains cerium metal in the range of 0.11% by mass or more and 1.35% by mass or less.

2. (canceled)

3. A cold cathode fluorescent lamp comprising a transparent tube having a fluorescent layer provided on an inner wall surface, containing a rare gas and mercury inside, and having both ends enclosed by sealing members, electrodes provided near both ends inside the transparent tube, and lead wires connected to the electrodes and provided through the sealing members, characterized in that the electrode contains nickel as a main component and contains cerium oxide in the range of 0.18% by mass or more and 1.61% by mass or less.

4. The cold cathode fluorescent lamp according to claims 1, characterized in that the electrode comprises any one or two or more of lanthanum, neodymium, or praseodymium.

5. The cold cathode fluorescent lamp according to claim 1, characterized in that the electrode contains yttrium in the range of 0.05% by mass or more and 0.5% by mass or less.

6. The cold cathode fluorescent lamp according to claim 1, characterized in that the electrode contains titanium in the range of 0.01% by mass or more and 0.05% by mass or less.

7. (canceled)

8. The cold cathode fluorescent lamp according to claim 1 characterized in that the electrode is fabricated using an ingot material comprising at least nickel and cerium metal, or an ingot material comprising at least nickel and cerium oxide.

9. The cold cathode fluorescent lamp according to any of claims 4, characterized in that the electrode contains yttrium in the range of 0.05% by mass or more and 0.5% by mass or less.

10. The cold cathode fluorescent lamp according to any of claims 4, characterized in that the electrode contains titanium in the range of 0.01% by mass or more and 0.05% by mass or less.

11. The cold cathode fluorescent lamp according to any of claims 9, characterized in that the electrode contains titanium in the range of 0.01% by mass or more and 0.05% by mass or less.

12. The cold cathode fluorescent lamp according to claims 3, characterized in that the electrode comprises any one or two or more of lanthanum, neodymium, or praseodymium.

13. The cold cathode fluorescent lamp according to any of claims 3, characterized in that the electrode contains yttrium in the range of 0.05% by mass or more and 0.5% by mass or less.

14. The cold cathode fluorescent lamp according to any of claims 3, characterized in that the electrode contains titanium in the range of 0.01% by mass or more and 0.05% by mass or less.

15. The cold cathode fluorescent lamp according to any of claims 12, characterized in that the electrode contains yttrium in the range of 0.05% by mass or more and 0.5% by mass or less.

16. The cold cathode fluorescent lamp according to any of claims 12, characterized in that the electrode contains titanium in the range of 0.01% by mass or more and 0.05% by mass or less.

17. The cold cathode fluorescent lamp according to any of claims 15, characterized in that the electrode contains titanium in the range of 0.01% by mass or more and 0.05% by mass or less.

18. The cold cathode fluorescent lamp according to any of claims 3
characterized in that the electrode is fabricated using an ingot material comprising at least nickel and cerium metal, or an ingot material comprising at least nickel and cerium oxide.

19. The cold cathode fluorescent lamp according to any of claims 4 characterized in that the electrode is fabricated using an ingot material comprising at least nickel and cerium metal, or an ingot material comprising at least nickel and cerium oxide.

20. The cold cathode fluorescent lamp according to any of claims 5 characterized in that the electrode is fabricated using an ingot material comprising at least nickel and cerium metal, or an ingot material comprising at least nickel and cerium oxide.

21. The cold cathode fluorescent lamp according to any of claims 6 characterized in that the electrode is fabricated using an ingot material comprising at least nickel and cerium metal, or an ingot material comprising at least nickel and cerium oxide.

22. The cold cathode fluorescent lamp according to any of claims 9 characterized in that the electrode is fabricated using an ingot material comprising at least nickel and cerium metal, or an ingot material comprising at least nickel and cerium oxide.

23. The cold cathode fluorescent lamp according to any of claims 10 characterized in that the electrode is fabricated using an ingot material comprising at least nickel and cerium metal, or an ingot material comprising at least nickel and cerium oxide.

24. The cold cathode fluorescent lamp according to any of claims 11 characterized in that the electrode is fabricated using an ingot material comprising at least nickel and cerium metal, or an ingot material comprising at least nickel and cerium oxide.

25. The cold cathode fluorescent lamp according to any of claims 12 characterized in that the electrode is fabricated using an ingot material comprising at least nickel and cerium metal, or an ingot material comprising at least nickel and cerium oxide.

26. The cold cathode fluorescent lamp according to any of claims 13 characterized in that the electrode is fabricated using an ingot material comprising at least nickel and cerium metal, or an ingot material comprising at least nickel and cerium oxide.

27. The cold cathode fluorescent lamp according to any of claims 14
characterized in that the electrode is fabricated using an ingot material comprising at least nickel and cerium metal, or an ingot material comprising at least nickel and cerium oxide.

28. The cold cathode fluorescent lamp according to any of claims 15 characterized in that the electrode is fabricated using an ingot material comprising at least nickel and cerium metal, or an ingot material comprising at least nickel and cerium oxide.

29. The cold cathode fluorescent lamp according to any of claims 16 characterized in that the electrode is fabricated using an ingot material comprising at least nickel and cerium metal, or an ingot material comprising at least nickel and cerium oxide.

30. The cold cathode fluorescent lamp according to any of claims 17 characterized in that the electrode is fabricated using an ingot material comprising at least nickel and cerium metal, or an ingot material comprising at least nickel and cerium oxide.
